(19) United States
(12) Patent Application Publication
(10) Pub. No.: US 2009/0199449 A1
(43) Pub. Date: Aug. 13, 2009

(54) Personalized identifying product system

(76) Inventors: Jonathan Isserow, Basking Ridge, NJ (US); Laura Isserow, Basking Ridge, NJ (US)

Correspondence Address: GEARHART LAW, LLC, 4 FERNDALE ROAD, CHATHAM, NJ, 07928, US

(21) Appl. No.: 12/321,030

(22) Filed: Jan. 15, 2009

Related U.S. Application Data
(60) Provisional application No. 61/065,101, filed on Feb. 9, 2008.

(51) Int. Cl. G09F 3/00; G09F 3/08

(52) U.S. Cl. 40/662; 40/299.01

(57) ABSTRACT

The invention is an article of manufacture comprising an ornamentalized identification tag and means for attaching the ornamentalized identification tag to an object.

### CLAIM OF PRIORITY

This application claims priority to U.S. Provisional Application No. 61/065,101 filed Feb. 9, 2008, which is fully incorporated herein by reference.

### FIELD OF THE INVENTION

The invention relates to the field of the ornamentalization of individual personal items.

### BACKGROUND OF THE INVENTION

The present invention relates to the ornamentalization of individual personal items for identification, amusement and fashion.

### SUMMARY OF THE INVENTION

The invention is an article of manufacture comprising an ornamentalized identification tag and means for attaching the ornamentalized identification tag to an object.

The invention solves the problem of users' being unable to distinguish their backpack or other personal item from other users' items in a situation where more than one person is or has been present, or where personal items have been stored or grouped together, such as in a classroom, gymnasium, or anyplace that multiple users gather and remove their backpacks or temporarily surrender possession of or set down their personal items.

The invention also provides a means of expressing creativity and individuality through the ornamentalization of a tag for a personal product.

The invention further provides a means for new methods of marketing by providing a venue to display advertising and promotion for businesses or events.

This ornamentalization may include but not be limited to, letters, words, pictures or drawings, photos, digitally produced images, pre-printed outlines of characters or scenes that are provided for users to embellish, the use of three dimensional objects such as but not limited to mosaics, beads, or items strung on a chain or rope and attached to the tag.

Storage items that may be ornamentalized include but are not limited to backpacks, fanny packs, purses and handbags, wallets, gym bags, dance bags, sports bags, luggage, and lunch boxes. Other items include but are not limited to clothing, such as coats, jackets and vests (for instance, on the zipper pull or pulls), or caps (for instance, on the strap in back of a baseball cap), shoes or boots (for instance, through the laces), jeans or other pants (for instance, through the belt-loop). Other personal use items that may be ornamentalized include but are not limited to, umbrellas (specifically the handles); camp supplies such as but not limited to sleeping bags, toothbrush cases, soap cases; straps or hooks to carry shoes or boots; baby bottles; hand-held electronic devices such as but not limited to cell phones or ipods; eyeglasses or eyeglass cases; contact lens cases; dental storage devices such as retainer cases; key chains; hairbrushes or combs; toothbrushes; or cosmetics such as but not limited to lipstick, lip gloss, chap stick or eye-liner.

The invention includes a kit for ornamentalizing the identification tag. The kit includes the tag, the means of attaching the tag to a personal item, and the ornamentation. The ornamentation may be comprised of a variety of items, including but not limited to, marking pens, crayons or pencils; paints; beads; colored thread; metalized thread; sequins; yam; feathers; fabric or paper cut into shapes, characters or letters; embellishments such as plastic eyes, puffs, magnets, or any suitable craft item.

It is an object of the invention to provide tags that can be ornamentalized.

It is an object of the invention to provide a means of attaching the ornamentalized tags to personal items.

It is an object of the invention to provide a means for creativity and self-expression.

It is an object of the invention to add a distinguishing feature to personal items for identification purposes.

It is an object of the invention to add a removable or alterable distinguishing feature to personal items.

It is an object of the invention to enable the personalization of backpacks or other personal storage items.

It is an object of the invention to enable the personalization of clothing.

It is an object of the invention to enable the personalization of personal items.

It is an object of the invention to promote sponsorship and advertising by allowing the placement of a logo, advertisement, photo or other promotional item on a tag for personal items.

It is an object of the invention to display personal artwork.

It is an object of the invention to provide a kit for producing an ornamentalized tag that can be attached to a personal item.

### BRIEF DESCRIPTION OF THE DRAWINGS

FIG. 1 is a perspective view of a preferred embodiment of the invention, showing five different embodiments of the invention on a backpack.

### DESCRIPTION OF THE PREFERRED EMBODIMENTS

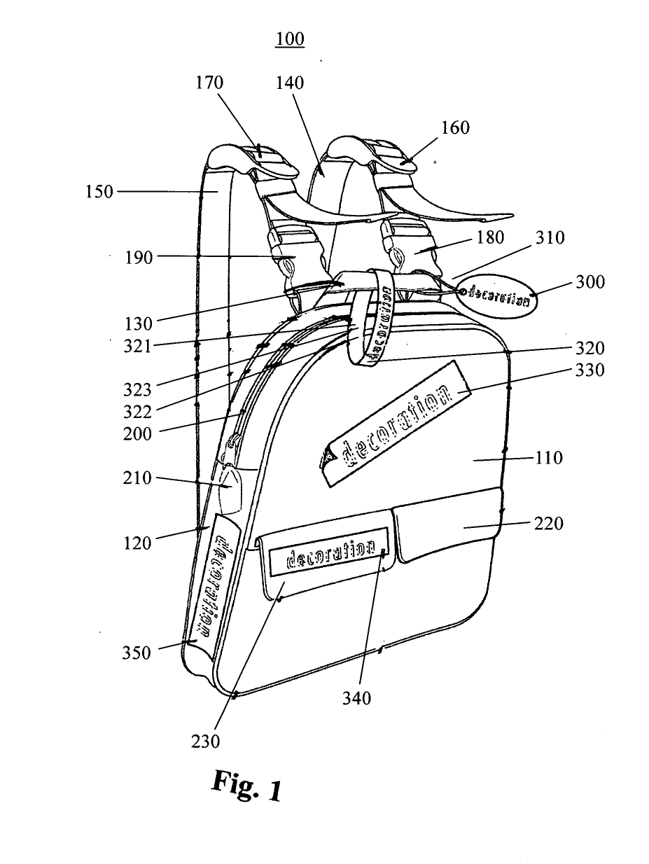

The preferred embodiments of the present invention will now be described with reference to FIG. 1.

The embodiments shown in FIG. 1 employ an ornamentalized, personalized device which is an addition to a personal item and that allows for differentiation of personal items which otherwise would be similar or identical to each other.

FIG. 1 shows a backpack 100 with front surface 110, right side surface 120, handle 130, left strap 140, right strap 150, left strap adjustment assembly 160, and right strap adjustment assembly 170. Backpack 100 also has a left strap fastener 180, right strap fastener 190, zipper 200, zipper pull 210, left pocket flap 220, and right pocket flap 230.

FIG. 1 illustrates the invention with five preferred embodiments. Preferred embodiment one is an ornamentalized identification tag 300, with an attachment means 310. Preferred embodiment two is an ornamentalized identification band 320, with a left end 321, a right end 322, and an ends union 323. Preferred embodiment three is an ornamentalized hook and loop backed identification tag 330, which may or may not have a corresponding hook and loop attachment on the backpack 100. Preferred embodiment four is an ornamentalized identification tag label 340, and preferred embodiment five is an ornamentalized identification tag patch 350.

A sixth preferred embodiment is a kit comprising an ornamentalizable identification tag having means for attaching to an object and ornamentation suitable for decorating the tag. Thus, a kit may include an oval tag, a leather thong for attaching it to the personal item, a crimp bead for crimping the thong to itself to secure it as a loop, and, for example, cat components, such as felt ears, plastic whiskers, plastic eyes, a fabric nose and a felt tail.

The ornamentalized identification tag 300 may be any length, width, or depth, with a preferred length of 3 inches, a preferred width of 1 inch, and a preferred depth of ⅛ inch. Although shown as an oval, the ornamentalized identification tag may be any shape, including but not limited to an oval, square, triangle, diamond, star, rectangle, polygon, circle or combination thereof. Although shown on the backpack handle, the tag may be attached to any portion of the personal item.

The ornamentalized tag attachment means 310 may include, but not be limited to, a strap that is fastened using, but not limited to, hook and loop fasteners (such as but not limited to Velcro™), snaps, rivets, jewelry crimp beads, tie strings, stitching, or adhesion methods including but not limited to, heat fusing or gluing. The strap may also be fastened by pinning or stapling.

The ornamentalized identification band 320 may be any width or length, with a preferred width of 1 inch and a preferred length of 9½ inches, and may wrap around the personal item any number of times or any fraction of one time. It is preferred to be constructed to be wrapped around and fastened to itself or to the personal item by an adhesive or other closure method such as, but not limited to, hook and loop fasteners, snaps, rivets, tie strings, stitching, or by pinning or stapling. It may also be of any geometrical shape, including a rectangular strip as shown, rectangular with the top or bottom or both edges serrated, or any geometric shape including but not limited to a triangle, star, square, polygon, circle or combination thereof, including multiple repeats of shapes. Although shown on the backpack handle, the tag may be attached to any portion of the personal item.

The ornamentalized identification hook and loop backed tag 330 may have a corresponding hook and loop on the personal item, or the personal item, such as a backpack, may have a surface that is coarse enough to act as a hook and eye attachment surface. It may also be of any geometrical shape, including a rectangular strip as shown, rectangular with the top or bottom or both edges serrated, or any geometric shape including but not limited to a triangle, star, square, polygon, circle or combination thereof, including multiple repeats of shapes. Although shown on the backpack front, the tag may be attached to any portion of the personal item.

The ornamentalized identification tag label 340 and the ornamentalized identification tag patch 350 may be adhered to the personal item by various means, including but not limited to, adhering with an adhesive agent, stitching, heat transfer, heat fusing, riveting, or by temporary means such as pinning or stapling the label or patch to the item. Although shown on the backpack front and side, the tag may be attached to any portion of the personal item.

The placement of designs, wherein the term “designs” means patterns, photos, personalizations, logos, jokes, or any writing, on the invention may employ, but is not limited to, the following methods: having designs printed on the invention, engraving designs, burning designs into the surface, hand-drawing designs, coloring designs using tools that include but are not limited to markers, paints, pens, pencils, or crayons. The designs may be cut out of the invention substrate material by die-cutting or other cutting methods, or design stickers may be placed on the invention. Designs may be hot stamped or silk screened onto the invention surface, or placed on the surface using adhesion agents such as, but not limited to, glue or rubber cement.

The designs may be placed on any fraction of the invention or on the entire surface. Designs may be original or may be pre-existing.

Other ornamentalization may be done using materials that are attached, adhered, stitched or embroidered to the invention substrate, including but not limited to, beads; colored thread; metalized thread; sequins; yarn; feathers; fabric cut into shapes, characters or letters; embellishments such as plastic eyes, puffs, magnets, or any suitable craft item.

The invention may use any materials in the tag substrate or embellishing items, including but not limited to, paper, metal, plastic, spandex, elastomers, rubber, vinyl, elastic, cellophane, cloth, feathers, fur, or other animal components, cardstock, cardboard, wood, metal, wax, foil, food, glass, ceramic, thermoplastics, a composite material, or any combination of materials.

The kit embodiment of the invention may include any or all of the materials and items described above in any combination. It may include materials to make one or more tags, either all of the same specific shape or type or any combination shapes and types. The kit may contain, but not be limited to, patterns for the tag designs, writing tools, tag covers and protectors, tools for cutting the materials in the kit, tools for transferring designs to the tags. Also included are tools such as, but not limited to, software or hardware to download digital images or computer generated images onto the tags.

Although this invention has been described with a certain degree of particularity, it is to be understood that the present disclosure has been made only by way of illustration and that numerous changes in the details of construction and arrangement of parts may be resorted to without departing from the spirit and the scope of the invention.

We claim:

1. An article of manufacture comprising:
an ornamentalized identification tag; and
means for attaching the ornamentalized identification tag to an object.

2. The article of claim 1, wherein the means for attaching is hook and loop fasteners.

3. The article of claim 1, wherein the ornamentalized identification tag has first and second ends, and the first and second ends are removably fastened together.

4. The article of claim 1, wherein the object is a backpack.

5. The article of claim 4, wherein the ornamentalized identification tag is attached to the backpack using hook and loop fasteners.

6. The article of claim 1, wherein the ornamentalized identification tag is customized for a user.

7. The article of claim 1, wherein the ornamentalized identification tag is customized by a user using ornamentation selected from the group consisting of beads, metalized thread, sequins, and stitching.

8. The article of claim 5, wherein the ornamentalized identification tag is customized by a user using ornamentation selected from the group consisting of beads, metalized thread, sequins, paint, coloring, and stitching, and stickers.

9. The article of claim 1, wherein the ornamentalized identification tag is made from plastic, paper, leather, cloth, rubber or combinations thereof.

10. A kit, comprising:
an ornamentalizable identification tag having means for attaching to an object; and
ornamentation suitable for decorating the identification tag.

11. The kit of claim 10, wherein the means for attaching is hook and loop fasteners.

12. The kit of claim 10, wherein the ornamentalizable identification tag has first and second ends, and the first and second ends are removably fastened together.

13. The kit of claim 10, wherein the object is a backpack.

14. The kit of claim 13, wherein the ornamentalizable identification tag is attached to the backpack using hook and loop fasteners.

15. The kit of claim 10, wherein the ornamentalizable identification tag is customized for a user.

16. The kit of claim 10, wherein the ornamentallyizable identification tag is customized by a user using ornamentation selected from the group consisting of beads, metalized thread, sequins, and stitching.

17. The kit of claim 14, wherein the ornamentation is selected from the group consisting of beads, metalized thread, sequins, paint, coloring, and stitching.

18. The kit of claim 10, wherein the ornamentalizable identification tag is made from plastic, paper, leather, cloth, rubber or combinations thereof.
